(19) United States
(12) Patent Application Publication
(10) Pub. No.: US 2007/0104331 A1
(43) Pub. Date: May 10, 2007

(54) Multi-channel audio system and method for generating virtual speaker sound

(75) Inventors: Tokihiko Sawashi, Tokyo (JP); Masahiro Okuno, Kanagawa (JP); Koji Kobayashi, Kanagawa (JP); Yasuyuki Kino, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/583,202

(22) Filed: Oct. 18, 2006

(30) Foreign Application Priority Data
Oct. 19, 2005 (JP) P2005-304703

(51) Int. Cl. H04R 5/00; H04R 5/02

(52) U.S. Cl. 381/18; 381/19; 381/310

(57) ABSTRACT

To realize sound output so that a listener does not feel unnaturalness, an audio signal for a center speaker is multiplied by a transfer function for a left speaker and a transfer function for a right speaker, respectively, and an audio component for a left center speaker and an audio component for a right center speaker that correspond to a listening point are generated. An audio signal for the left speaker and an audio signal for the right speaker are synthesized with the audio component for the left center speaker and the audio component for the right center speaker, respectively. Thereby, a sound image can be oriented as if a sound based on the audio signal for the center speaker is emitted from a position at which a center speaker would be set if the system had a center speaker.

### CROSS-REFERENCE TO RELATED APPLICATIONS

The present application claims priority from Japanese Patent Application No. JP2005-304703 filed on Oct. 19, 2005, the disclosure of which is hereby incorporated by reference herein.

### BACKGROUND OF THE INVENTION

1. Field of the Invention

The present invention relates to a multi-channel audio system and a method for generating a virtual speaker sound, and is applicable to a vehicle audio system, for example.

2. Description of the Related Art

Heretofore, as a vehicle audio system, a 4 channel multi-channel audio system is generally available in which two front speakers are set on a driver's seat side and a passenger seat side and two rear speakers are set on a rear seat side in a car interior space.

Such multi-channel audio system does not have a center speaker. Therefore, there is a multi-channel audio system in that a center channel audio signal for the center speaker is allocated to a left speaker and a right speaker (see Japanese Patent Laid-Open No. H11-113098, for example).

Furthermore, in a multi-channel audio system, the necessary number of speakers to make the user listen to a multi-channel audio source such as 5.1 channel, is larger than in stereo reproduction. However, there is a case difficult to set a center speaker, in a space having many limitations in the installation of speakers such as a car interior space.

Furthermore, generally, sounds to be emitted from a center speaker are often music vocals, speeches in a movie, or the like. Therefore, it is desirable that the emitting position of the above sounds corresponds to a video monitor to be installed at the center between a driver's seat and a passenger seat.

Heretofore, as shown in FIG. 1, in a multi-channel audio system 1 without a center speaker, the gain control of an audio signal for center speaker Cout that was entered from an input terminal 7 is performed by an amplifier 2, and thus obtained signal is transmitted to synthesizing circuits 3 and 4 as audio signals for center speaker LCout and RCout.

An audio signal for left front speaker Lout is supplied to the synthesizing circuit 3 via an input terminal 8. The synthesizing circuit 3 synthesizes the above audio signal for center speaker LCout with the above audio signal for left front speaker Lout, and generates an audio signal for left front speaker FL1 by that the component of the audio signal for center speaker LCout was downmixed. The audio signal FL1 is amplified by an amplifier 21, and then a sound corresponding to the above amplified audio signal for left front speaker FL1 is emitted from a left front speaker 5.

On the other hand, an audio signal for right front speaker Rout is supplied to the synthesizing circuit 4 via an input terminal 9. The synthesizing circuit 4 synthesizes the above audio signal for center speaker RCout with the above audio signal for right front speaker Rout, and generates an audio signal for right front speaker FR1 by that the component of the audio signal for center speaker RCout was downmixed. The audio signal FR1 is amplified by an amplifier 22, and then a sound corresponding to the above amplified audio signal for right front speaker FR1 is emitted from a right front speaker 6.

By the way, in a multi-channel audio system 1 having the above configuration, if a listener listens sounds at an almost center position between a left front speaker 5 and a right front speaker 6, the sound images of sound parts corresponding to an audio signal for center speaker LCout and an audio signal for center speaker RCout downmixed with an audio signal for left front speaker FL1 and an audio signal for right front speaker FR1 respectively are oriented near a video monitor provided at an almost center position between the left front speaker 5 and the right front speaker 6. However, if the position of the listener is not at an almost center position between the left front speaker 5 and the right front speaker 6, the sound images are not oriented near the video monitor.

Therefore, particularly, in the case where the multi-channel audio system 1 is installed in a car interior space, if the listener is on a driver's seat, the orientation position of the sound images of the audio signal for center speaker LCout and the audio signal for center speaker RCout is shifted to the right front speaker 6 side that is close to the listener. Thus, there has been a problem that the listener cannot feel that music vocals, speeches in a movie or the like are emitted from near the video monitor and feels unnaturalness.

In view of the foregoing, it is desirable to provide a multi-channel audio system and a method for generating virtual speaker sounds enabling sound output in that a listener does not feel unnaturalness.

### SUMMARY OF TRE INVENTION

According to an embodiment of the present invention, in a multi-channel audio system and a method for generating virtual speaker sounds, an audio signal for a center speaker is multiplied by a transfer function for a left speaker and a transfer function for a right speaker, respectively, and an audio component for a left center speaker and an audio component for a right center speaker that correspond to a listening point are generated. The audio component for the left center speaker and the audio component for the right center speaker are synthesized with an audio signal for the left speaker and an audio signal for the right speaker, respectively. Thereby, sound images can be oriented as if a sound based on the audio signal for the center speaker is emitted from a position at which a center speaker would be set if the system had a center speaker.

According to an embodiment of the present invention, a left speaker and a right speaker are set around a listener in a predetermined space. An audio signal for the left speaker and an audio signal for the right speaker are supplied. An audio signal is supplied for a center speaker corresponding to a virtual center speaker having a virtual position between the left speaker and the right speaker. A first transfer function is calculated for the left speaker and a second transfer function is calculated for the right speaker in the predetermined space so that a sound based on the audio signal for the center speaker is emitted from the virtual center speaker at a predetermined listening point in the predetermined space. The first transfer function for the left speaker and the second transfer function for the right speaker are multiplied by the audio signal for the center speaker, and an audio component for a left center speaker and an audio component for a right center speaker corresponding to the listening point are generated. And the audio component for the left center speaker is synthesized with the audio signal for the left speaker to produce a first resultant signal, and then the first resultant signal is transmitted to the left speaker, and also the audio component for the right center speaker is synthesized with the audio signal for the right speaker to generate a second resultant signal, and then the second resultant signal is transmitted to the right speaker.

The nature, principle and utility of the present invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic block diagram showing the circuit configuration of a conventional multi-channel audio system;

FIG. 2 is a schematic diagram for explaining the principle of a multi-channel audio system according to an embodiment of the present invention;

FIG. 3 is a schematic block diagram showing a positional relationship in consideration of the height direction of a virtual center speaker; and

FIG. 4 is a schematic block diagram showing the circuit configuration of a multi-channel audio system according to an embodiment of the present invention.

### DETAILED DESCRIPTION

Preferred embodiments of the present invention will be described with reference to the accompanying drawings:

### (1) Principle

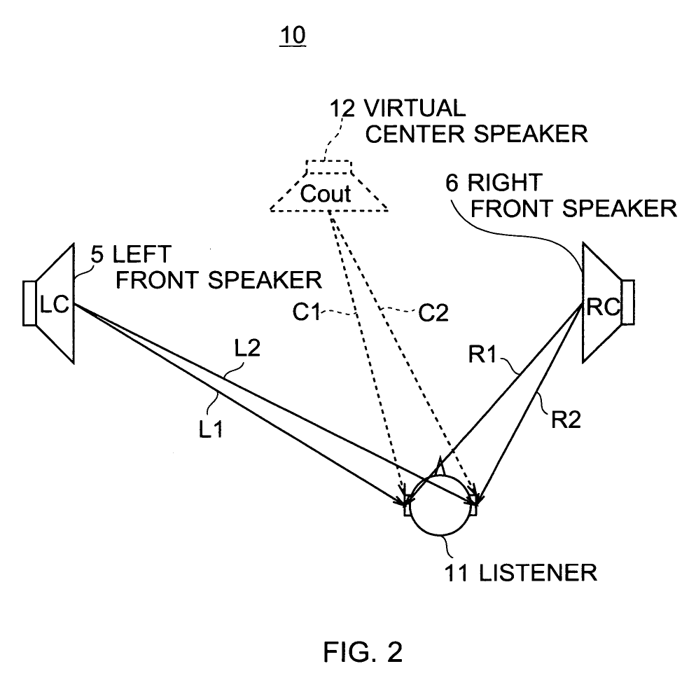

As shown in FIG. 2, in a multi-channel audio system 10 of an embodiment of the present invention, in a car interior space that is difficult to set a center speaker, an audio signal for center speaker is subjected to signal processing so that for example a listener 11 on a driver's seat can hear as if sounds for center speaker are emitted from the position of a virtual center speaker 12 where normally a center speaker should be set. The resultant signal of the signal processing is synthesized with an audio signal for left front speaker to be transmitted to a left front speaker 5 and an audio signal for right front speaker to be transmitted to a right front speaker 6 (hereinafter, this is referred to as downmix). Thereby, the listener 11 has an impression that as if sounds for center speaker are emitted from the position of the virtual center speaker 12.

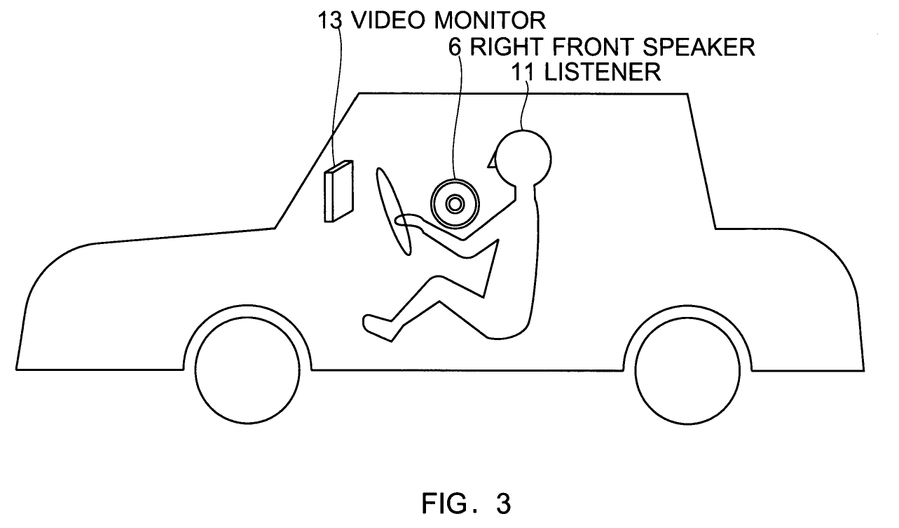

Specifically, since audio signals for center speaker are generally music vocals, speeches in a movie, or the like, the position of the virtual center speaker 12 is assumed to be a position where a video monitor 13 is set as shown in FIG. 3. That is, as the position of the virtual center speaker 12, also the height has been considered not only that it is an almost center position between the left front speaker 5 and the right front speaker 6.

Practically, an audio component for left center speaker LC to be emitted from the left front speaker 5 (FIG. 2) reaches the left ear of the listener 11 by a transfer function L1, and reaches the right ear by a transfer function L2. On the other hand, an audio component for right center speaker RC to be emitted from the right front speaker 6 reaches the left ear of the listener 11 by a transfer function R1, and reaches the right ear by a transfer function R2.

Here, if it is assumed that an audio signal for center speaker Cout is emitted from the virtual center speaker 12, the audio signal for center speaker Cout reaches the left ear of the listener 11 by a transfer function C1, and the audio signal for center speaker Cout reaches the right ear by a transfer function C2.

The relationship among these audio component for left center speaker LC, audio component for right center speaker RC, their transfer functions L1, L2, R1 and R2, the audio signal for center speaker Cout, and their transfer functions C1, C2 is represented as the following equation:
Cout×C1=(LC×L1)+(RC×R1) (1)
Cout×C2=(LC×L2)+(RC×R2) (2)
If transforming this Equation (1), it is represented by the following equation:
LC=((R2×C1)−(R1×C2))×Cout/((L1×R2)−(L2×R1)) (3)
If transforming Equation (2), it is represented by the following equation:
RC=((L1×C2)−(L2×C1))×Cout/((L1×R2)−(L2×R1)) (4)

By the way, the audio component for left center speaker LC to be emitted from the left front speaker 5 is that a predetermined transfer function H1 in the above car interior space was multiplied by the audio signal for center speaker Cout to be emitted from the virtual center speaker 12. The audio component for right center speaker RC to be emitted from the right front speaker 6 is that a predetermined transfer function H2 in the above car interior space was multiplied by the audio signal for center speaker Cout to be emitted from the virtual center speaker 12. Relationships among them are represented by the following equations:
LC=H1×Cout (5)
RC=H2×Cout (6)

From the relationships between the aforementioned Equations (3) and (4), and Equations (5) and (6), the transfer functions H1 and H2 are represented by the following equations, respectively.
H1=((R2×C1)−(R1×C2))/((L1×R2)×(L2×R1)) (7)
H2=((L1×C2)−(L2×C1))/((L1×R2)−(L2×R1)) (8)

As to the transfer functions L1, L2, the transfer functions R1, R2, and the transfer functions C1, C2 forming these transfer functions H1 and H2, it is necessary to be practically previously calculated in a car interior space. In the multi-channel audio system 10, the transfer functions H1 and H2 can be easily obtained based on Equations (7) and (8) using the calculated values.

In this case, the position of the virtual center speaker 12 is assumed to be the position where the video monitor 13 is set as shown in FIG. 3. Therefore, the transfer functions L1, L2, the transfer functions R1, R2, and the transfer functions C1, C2 practically calculated are the values that were also considered in a height direction in the relationship between the listener 11 and the virtual center speaker 12.

As a method for calculating such transfer functions L1, L2, transfer functions R1, R2, and transfer functions C1, C2, for example, a sound corresponding to an impulse signal is practically emitted from the left front speaker 5, the right front speaker 6, and a temporal center speaker (not shown) corresponding to the virtual center speaker 12, and the sound is picked up with a microphone not shown, or the like. And the transfer functions are calculated by obtaining a temporal variation and a variation in level in the impulse signal at a certain time.

Therefore, in the multi-channel audio system 10, provided that an audio signal for center speaker Cout to be emitted from the virtual center speaker 12 is supplied from a sound source, the audio component for left center speaker LC to be emitted from the left front speaker 5 and the audio component for right center speaker RC to be emitted from the right front speaker 6 can be immediately calculated based on Equations (5) and (6).

The synthesized result of the audio component for left center speaker LC to be emitted from the left front speaker 5 with the audio signal for left front speaker is outputted from the left front speaker 5, and the synthesized result of the audio component for right center speaker RC to be emitted from the right front speaker 6 with the audio signal for right front speaker is outputted from the right front speaker 6. Thereby, as to sound parts corresponding to the audio component for left center speaker LC and the audio component for right center speaker RC, the sound images can be oriented as if they are emitted from the virtual center speaker 12.

### (2) Concrete Configuration

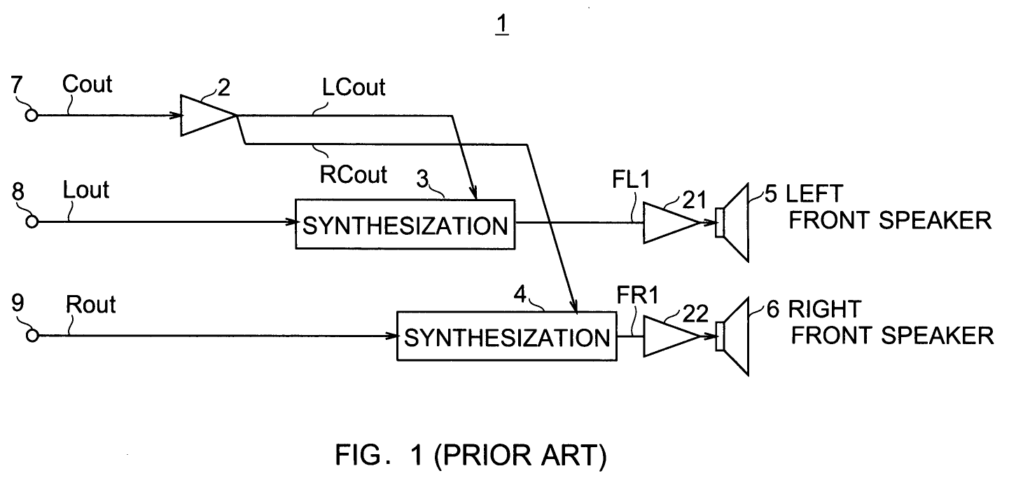

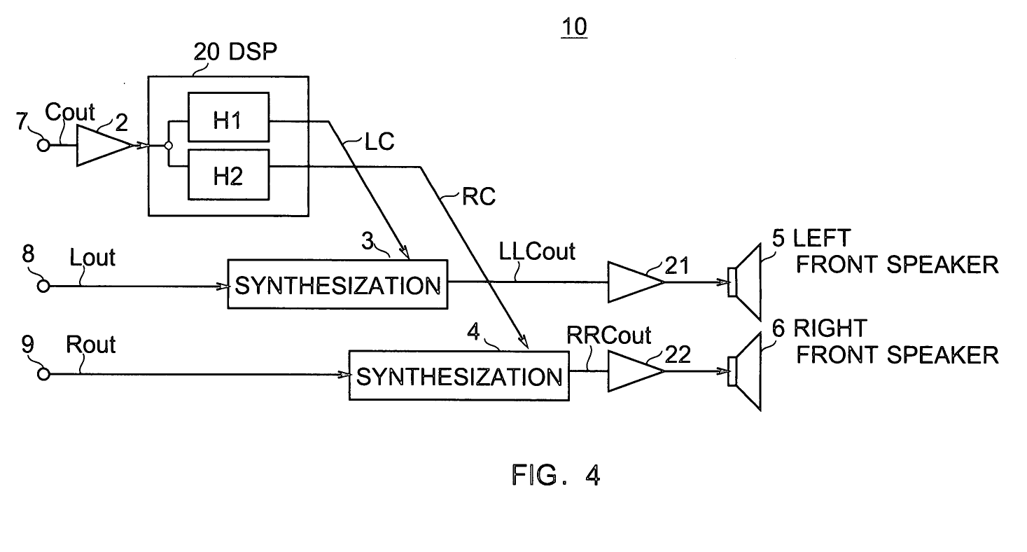

Next, the circuit configuration of a multi-channel audio system 10 for realizing the aforementioned principle will be concretely described. As shown in FIG. 4 in that the same reference numerals are added to the corresponding parts in FIG. 1, the gain control of an audio signal for center speaker Cout entered from an input terminal 7 is performed by an amplifier 2, and then the resultant signal is supplied to a Digital Signal Processor (DSP) 20.

In the DSP 20, transfer functions L1, L2, transfer functions R1, R2, and transfer functions C1, C2 have been previously calculated and held. Transfer functions H2 and H2 are calculated based on Equations (7) and (8). These transfer functions H1 and H2 are multiplied by the audio signal for center speaker Cout by using the Equations (5) and (6). Thereby, an audio component for left center speaker LC to be emitted from a left front speaker 5 and an audio component for right center speaker RC to be emitted from a right front speaker 6 are generated. The audio component for left center speaker LC is transmitted to a synthesizing circuit 3, and also the audio component for right center speaker RC is transmitted to a synthesizing circuit 4.

An audio signal for left front speaker Lout is supplied to the synthesizing circuit 3 via an input terminal 8. In the synthesizing circuit 3, the above audio component for left center speaker LC is synthesized with the above audio signal for left front speaker Lout, and a left audio signal LLCout by that the audio component for left center speaker LC was downmixed is generated. The above left audio signal LLCout is amplified to a predetermined level by an amplifier 21. Then, a sound corresponding to the left audio signal LLCout is emitted from the left front speaker 5.

On the other hand, an audio signal for right front speaker Rout is supplied to the synthesizing circuit 4 via an input terminal 9. In the synthesizing circuit 4, the above audio component for right center speaker RC is synthesized with the above audio signal for right front speaker Rout, and a right audio signal RRCout by that the audio component for right center speaker RC was downmixed is generated. The above right audio signal RRCout is amplified to a predetermined level by an amplifier 22. Then, a sound corresponding to the above right audio signal RRCout is emitted from the right front speaker 6.

### (3) Operation and Effect

According to the above configuration, in the multi-channel audio system 10, to make the listener 11 hear a sound for center speaker from a position where a sound corresponding to the audio signal for center speaker Cout is wanted to be practically emitted, that is, the position of the video monitor 13, a sound, for example, corresponding to an impulse signal is practically emitted from the left front speaker 5, the right front speaker 6, and a temporal center speaker (not shown) corresponding to the virtual center speaker 12. Then, transfer functions L1, L2, transfer functions R1, R2, and transfer functions C1, C2 are calculated based on the result that the sound was picked up with a microphone or the like, and they are previously held.

Therefore, in the multi-channel audio system 10, provided that the audio signal for center speaker Cout is supplied from a sound source via the input terminal 7, an audio component for left center speaker LC to be emitted from the left front speaker 5 and an audio component for right center speaker RC to be emitted from the right front speaker 6 can be generated, by calculating transfer functions H1 and H2 based on the aforementioned Equations (7) and (8), and multiplying these transfer functions H1 and H2 by the audio signal for center speaker Cout by using Equations (5) and (6).

In the multi-channel audio system 10, these audio component for left center speaker LC and audio component for right center speaker RC are synthesized with an audio signal for left front speaker Lout and an audio signal for right front speaker Rout respectively, and a left audio signal LLCout and a right audio signal RRCout are generated. Then, they are transmitted to the left front speaker 5 and the right front speaker 6 respectively.

As a result, in the multi-channel audio system 10, sounds corresponding to the left audio signal LLCout and the right audio signal RRCout are emitted from the left front speaker 5 and the right front speaker 6. However, since in these sounds, the audio component for left center speaker LC and the audio component for right center speaker RC are included, although a center speaker is not provided in a car interior space, the sound image of a sound for center speaker can be pseudly oriented as if the sound for center speaker is emitted from near the video monitor 13 for the listener 11 on a driver's seat.

Specifically, in the multi-channel audio system 10, it has been considered that the sound image of a sound for center speaker is oriented to a position adjusted to the height of the video monitor 13. Therefore, the multi-channel audio system 10 has a feature that the sound image of a sound for center speaker can be oriented to a specified position on a three-dimensional space also considered as to the height direction, in addition to the position in a horizontal direction being the almost center between the left front speaker 5 and the right front speaker 6.

Therefore, the multi-channel audio system 10 of an embodiment of the present invention is significantly different in the feeling of hearing of the listener 11, from the case where the listener 11 is not at an almost center position between the left front speaker 5 and the right front speaker 6, and the listener cannot hear the sound for center speaker as that the sound is emitted from near the video monitor 13, in the case where a sound for center speaker is simply allocated to the left front speaker 5 and the right front speaker 6 as the conventional case.

Practically, in the multi-channel audio system 10, music vocals, speeches in a movie, or the like that are frequently used in general as sounds for center speaker are heard from the video monitor 13. Thus, a video and sound space with reality in that a video display position and an sound emitting position are unified can be presented to the listener 11.

According to the above configuration, in the multi-channel audio system 10, the listener 11 on a driver's seat can pseudly listen to sounds for center speaker as if there is a center speaker that actually is not provided.

Specifically, in the multi-channel audio system 10, in the case where it is in a car interior space difficult to set a center speaker and a sound source has an audio signal for center speaker Cout, a virtual center speaker can be easily realized without making an improvement on the existent speaker arrangement such as providing a center speaker.

### (4) Other Embodiments

In the aforementioned embodiment, it has dealt with the case where transfer functions H1 and H2 are calculated adapting to the listener 11 on a driver's seat. However, the present invention is not only limited to this but also transfer functions H1 and H2 may be calculated adapting to a listener on a passenger's seat, a rear seat, or the like.

Further, in the aforementioned embodiment, it has dealt with the case where transfer functions H1 and H2 are calculated by assuming the virtual center speaker 12 at an almost center position between the left front speaker 5 and the right front speaker 6. However, the present invention is not only limited to this but also transmission functions may be calculated by assuming a virtual center speaker at an almost center position between a left rear speaker and a right rear speaker.

Further, in the aforementioned embodiment, it has dealt with the case where an impulse signal is used for previously calculating transfer functions L1, L2, transfer functions R1, R2, and transfer functions C1, C2. However, the present invention is not only limited to this but also various signals other than the impulse signal, such as a Time Stretched Pulse (TSP) signal or the like may be used.

Further, in the aforementioned embodiment, it has dealt with the case where the virtual center speaker 12 is assumed in the relationship between the left front speaker 5 and the right front speaker 6, and transfer functions H1 and H2 are calculated as if a sound for center speaker is emitted from the virtual center speaker 12. However, the present invention is not only limited to this but also in the case where a video monitor 13 is provided at the center of a car interior space in the state where a left front speaker, a right front speaker, a left rear speaker and a right rear speaker are set at the four corners of the car interior space, transfer functions H to be multiplied by an audio signal for center speaker Cout may be calculated as if a sound for center speaker is emitted from the video monitor set in the center of the car interior space. In this case, also transfer functions L, R of sounds that reach from the four speakers, and a transfer function C of a sound that reaches from a virtual center speaker corresponding to the virtual center speaker 12 may be previously calculated.

Further, in the aforementioned embodiment, it has dealt with the case where the multi-channel audio system 10 according to an embodiment of the present invention has the input terminals 8 and 9 serving as a main audio signal input section, the input terminal 7 serving as an audio signal for center speaker input section, the DSP 20 serving as a transfer function calculating section and an audio signal for pseudo center speaker generating section, and the synthesizing circuits 3 and 4 serving as synthesizing sections. However, the present invention is not only limited to this but also a multi-channel audio system may have a main audio signal input section, an audio signal for center speaker input section, a transfer function calculating section, an audio signal for pseudo center speaker generating section and a synthesizing section that have various circuit configurations other than that.

A multi-channel audio system and a method for generating virtual speaker sounds according to an embodiment of the present invention is applicable to realize a virtual center speaker without a center speaker, in the case where an audio system does not have a center speaker and an audio signal for center speaker is supplied from a sound source, in various listening environments such as a listening room and a movie theater.

According to an embodiment of the present invention, a transfer function for left speaker and a transfer function for right speaker are generated. They are multiplied by an audio signal for center speaker, and an audio component for left center speaker and an audio component for right center speaker that correspond to a listening point are generated. They are synthesized with an audio signal for left speaker and an audio signal for right speaker respectively. Thus, sound images can be oriented as if a sound based on the audio signal for center speaker is emitted from an installation position where if the system has a center speaker, the center speaker would be set. Thereby, a multi-channel audio system and a method for generating virtual speaker sounds enabling sound output in that a listener does not feel unnaturalness can be realized.

While there has been described in connection with the preferred embodiments of the present invention, it will be obvious to those skilled in the art that various changes, modifications, combinations, sub-combinations and alternations may be aimed, therefore, to cover in the appended claims all such changes, and modifications as fall within the true spirit and scope of the present invention.

1. A multi-channel audio system, comprising:
a left speaker and a right speaker set around a listener in a predetermined space;
a main audio signal input section operable to supply an audio signal for the left speaker and an audio signal for the right speaker;
an audio signal for a center speaker input section operable to supply an audio signal for a center speaker corresponding to a virtual center speaker having a virtual position between the left speaker and the right speaker;
a transfer function calculating section operable to calculate a first transfer function for the left speaker and a second transfer function for the right speaker in the predetermined space so that a sound based on the audio signal for the center speaker is emitted from the virtual center speaker at a predetermined listening point in the predetermined space;
an audio component for center speaker generating section operable to respectively multiply the first transfer function for the left speaker and the second transfer function for the right speaker by the audio signal for the center speaker, and to generate an audio component for a left center speaker and an audio component for a right center speaker that correspond to the listening point; and
a synthesizing section operable to synthesize the audio component for the left center speaker with the audio signal for the left speaker to produce a first resultant signal, and to transmit the first resultant signal to the left speaker, and to synthesize the audio component for the right center speaker with the audio signal for the right speaker to produce a second resultant signal, and to transmit the second resultant signal to the right speaker.

2. The multi-channel audio system according to claim 1, wherein
the transfer function calculating section is operable to calculate the first transfer function for the left speaker and the second transfer function for the right speaker based on a position of the virtual center speaker in a height direction in addition to the virtual position between the left speaker and the right speaker.

3. A method for generating virtual speaker sounds in a multi-channel audio system having a left speaker and a right speaker set around a listener in a predetermined space, the method comprising:
supplying an audio signal for the left speaker and an audio signal for the right speaker;
supplying an audio signal for a center speaker corresponding to a virtual center speaker having a virtual position between the left speaker and the right speaker;
calculating a first transfer function for the left speaker and a second transfer function for the right speaker in the predetermined space so that a sound based on the audio signal for the center speaker is emitted from the virtual center speaker at a predetermined listening point in the predetermined space;
respectively multiplying the first transfer function for the left speaker and the second transfer function for the right speaker by the audio signal for the center speaker, and generating an audio component for a left center speaker and an audio component for a right center speaker that correspond to the listening point;
synthesizing the audio component for the left center speaker with the audio signal for the left speaker to produce a first resultant signal, and transmitting the first resultant signal to the left speaker; and
synthesizing the audio component for the right center speaker with the audio signal for the right speaker to produce a second resultant signal, and transmitting the second resultant signal to the right speaker.

4. The method for generating virtual speaker sounds according to claim 3, wherein
the transfer function calculating step includes calculating the first transfer function for the left speaker and the second transfer function for the right speaker based on a position of the virtual center speaker in a height direction in addition to the virtual position between the left speaker and the right speaker.

5. A vehicle multi-channel audio system having a left front speaker and a right front speaker, and creating sound images oriented in a forward direction, comprising:
a left speaker and a right speaker set around a listener in a predetermined space;
a main audio signal input section operable to supply an audio signal for the left speaker and an audio signal for the right speaker;
an audio signal for a center speaker input section operable to supply an audio signal for a center speaker corresponding to a virtual center speaker having a virtual position between the left speaker and the right speaker;
a transfer function calculating section operable to calculate a first transfer function for the left speaker and a second transfer function for the right speaker in the predetermined space so that a sound based on the audio signal for the center speaker is emitted from the virtual center speaker at a predetermined listening point in the predetermined space;
an audio component for the center speaker generating section operable to respectively multiply the first transfer function for the left speaker and the second transfer function for the right speaker by the audio signal for the center speaker, and to generate an audio component for a left center speaker and an audio component for a right center speaker that correspond to the listening point; and
a synthesizing section operable to synthesize the audio component for the left center speaker with the audio signal for the left speaker to produce a first resultant signal, and to transmit the first resultant signal to the left speaker, and to synthesize the audio component for the right center speaker with the audio signal for the right speaker to produce a second resultant signal, and to transmit the second resultant signal to the right speaker.
